(19) United States
(12) Patent Application Publication
(10) Pub. No.: US 2009/0210817 A1
(43) Pub. Date: Aug. 20, 2009

(54) MECHANISM FOR INCREASING REMOTE DESKTOP RESPONSIVENESS

(75) Inventors: Wilhelm R. Schmieder, Snoqualmie, WA (US); Srinivasa R. Neerudu, Redmond, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/032,592

(22) Filed: Feb. 15, 2008

(51) Int. Cl. G06F 3/048

(52) U.S. Cl. 715/781

(57) ABSTRACT

Described techniques improve remote desktop responsiveness by prioritizing regions of a display output based on geometry data received from an operating system. Once prioritized, the regions are checked in order of priority for updates that the remote desktop client has yet to receive. If a region has been updated, data representing the updated region is transmitted from the remote desktop server to the remote desktop client.

### BACKGROUND

Remote desktop technologies allow a local user interacting with a local computer to control and view a remote desktop session originating from a remote computer. The local computer is commonly referred to as a remote desktop client, or simply a “client computer”, while the remote computer is commonly referred to as a remote desktop server, or “server computer.” User input originating at the client computer, such as keyboard and mouse input, is converted into a network-compatible representation and transmitted over a network to the server computer. The server computer receives the network-compatible representation of the user input and converts this representation into actual user input messages. The user input messages are then sent to the server computer's message queue and processed as if the input was generated at the server computer. Therefore, applications running on the server computer respond to the input as if the input was generated at the server computer.

In addition, applications running on the server computer (as well as the operating system running on the server computer) periodically update the server computer's graphics output. In the remote desktop scenario, the server computer's graphics output is not displayed on a monitor or other viewing device of the server computer, but rather is converted to a network-compatible representation and transmitted to the client computer. The network-compatible representation is received by the client computer and displayed to the user on a monitor or other device. In this way, what would be displayed by applications and the operating system running on the server computer is instead viewed by a user of the client computer.

Traditionally, remote desktop technologies have been implemented on the server computer with a special video driver configured to transmit graphics commands to the client computer, supplemented by the transmission of bitmaps. An application running on the remote computer invokes a graphics command, such as a GDI command, instructing the operating system to draw a particular shape or text string at a desired location in the graphics output. The special video driver receives this command and, in lieu of executing the command, transmits the command to the client computer. The client computer receives the command and forwards it to the local display driver to be processed and displayed to the user.

Unfortunately, current techniques fail to maximize responsiveness to user input. There is a continuing need to increase remote desktop performance and responsiveness by prioritizing the order in which regions of the server computer's graphics output are processed.

### SUMMARY

This document describes techniques to increase remote desktop responsiveness and efficiency in the absence of a special video driver configured to transmit graphics commands to the client computer. In one embodiment, these techniques pertain to a screen-scraping method of remote desktop. The server computer identifies updated regions in the server computer's graphics output, and transmits data representing the updated regions to the client computer. Responsiveness is increased by prioritizing the order in which the regions of the display are tested for updates, according to user expectations. The remote desktop user is rarely equally concerned with all regions of the graphics output. Knowing which regions the user is likely to be focused on and checking these regions for updates before other less relevant regions will increase perceived responsiveness without increasing bandwidth or processing power. Updated regions are then transmitted to the client according to the same priority. Emphasis is given to regions of the display that the user expects to be updated first. For example, regions of the display where the user is likely to be focused, such as regions containing the system cursor, the caret, the current active control, and the current active window, among others, are given priority.

In some instances, regions of the server computer's display are prioritized by considering geometry data from the user, the operating system, and from applications. Geometry data includes information collected from user interface (UI) elements. Geometry data includes but is not limited to: the position of UI elements, the size of UI elements, the z-axis position of UI elements, changes in UI elements, and the types of UI elements. Geometry data is used to prioritize which regions of the graphics output to check first for updates. Non-limiting examples of types of geometry data include the system cursor, the caret, window scroll events, window show events, window activation events, and window region invalidation events, among others.

For example, the caret indicates the insertion point in a document where text will appear in response to keyboard input. Because the caret typically indicates where the user's attention is focused and where updates are likely to occur, high priority is assigned to regions containing the caret in one embodiment.

Another type of geometry data is the invalidation of a region of a window on the server computer's graphics output. Invalidated regions must be re-painted, and so invalidated regions are more likely to change than regions that have not been invalidated. In one embodiment, this geometry data is a less reliable indicator of which region to check for updates first than the position of the caret, and so regions of the display that contain invalidated portions of a window are prioritized lower than regions containing the caret.

In another embodiment, the relative priorities assigned to each of the geometry data are determined in a schema file. In one embodiment the schema file may replace the default geometry data priorities. In another embodiment the schema file may indicate priorities specific to one or more applications. Application-specific priorities enable increased responsiveness by prioritizing regions according to the particular characteristics of that application.

In another embodiment, a remote desktop server receives information from a non-user initiated window message indicating a change to the remote desktop server's graphics output. For example, events generated in response to a window move, a window resize, or the first time a window has been shown, among others, are used to assign priorities to regions of the display. When a region of the server computer's graphics output is found to have been updated, data representing that region is transmitted to the remote desktop client.

### BRIEF DESCRIPTION OF THE CONTENTS

The detailed description is described with reference to accompanying figures. In the figures, the left-most digit(s) of a reference number identifies the figure in which the reference number first appears. The use of the same reference numbers in different figures indicates similar or identical items.

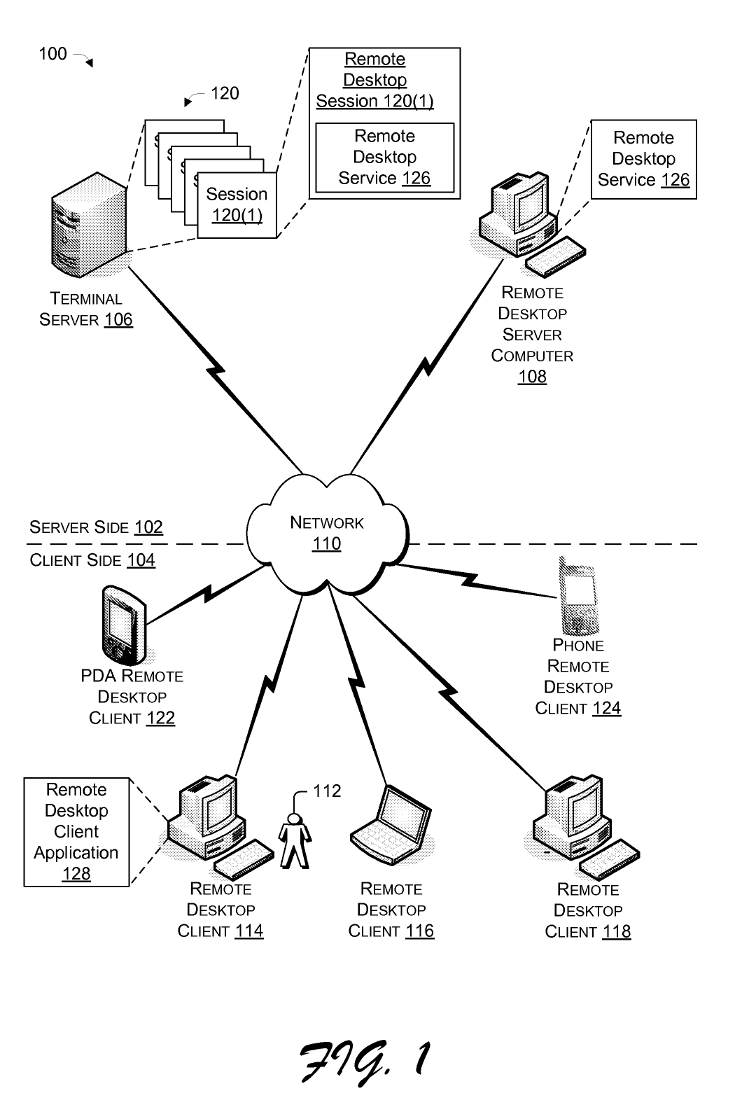

FIG. 1 illustrates a number of remote desktop scenarios. Here, server computers are connected to client computers through a network.

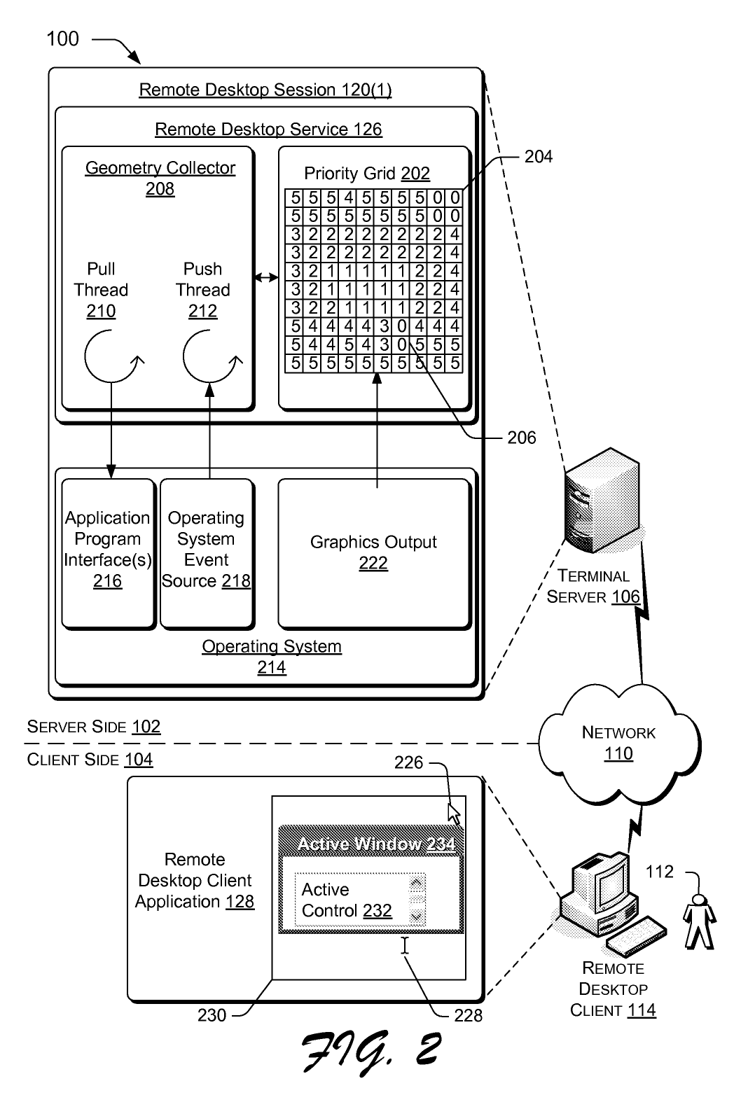

FIG. 2 depicts illustrative components of one of the server computers of FIG. 1. This server computer includes a priority grid, a geometry collector, and an operating system.

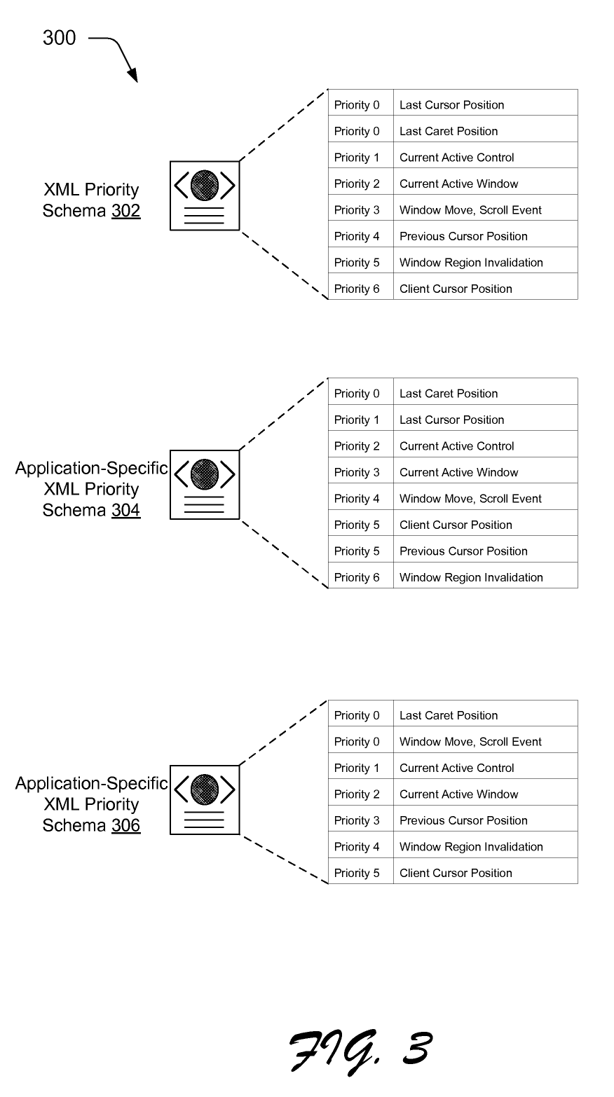

FIG. 3 depicts an illustrative set of XML schema files indicating priorities assigned to input data.

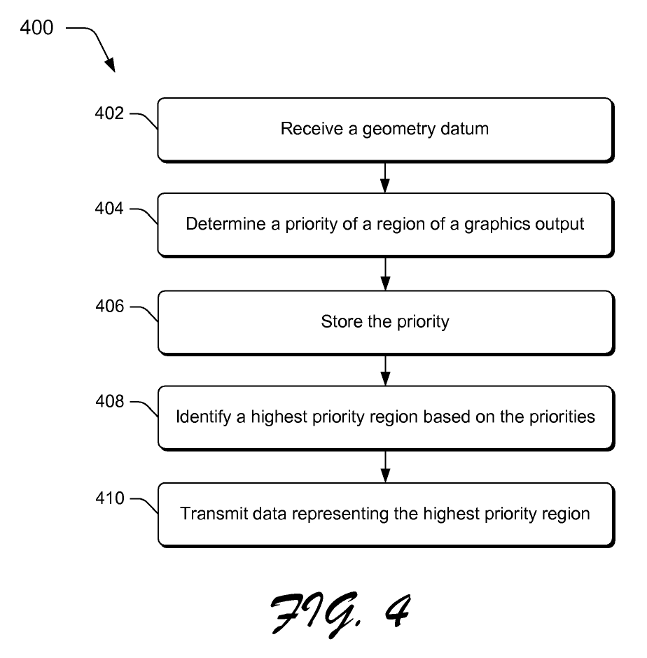

FIG. 4 depicts an illustrative process which allows a remote desktop server computer to receive geometry data, prioritize regions of the computer graphics output based on the geometry data, identify the highest priority region, and transmit data representing that region.

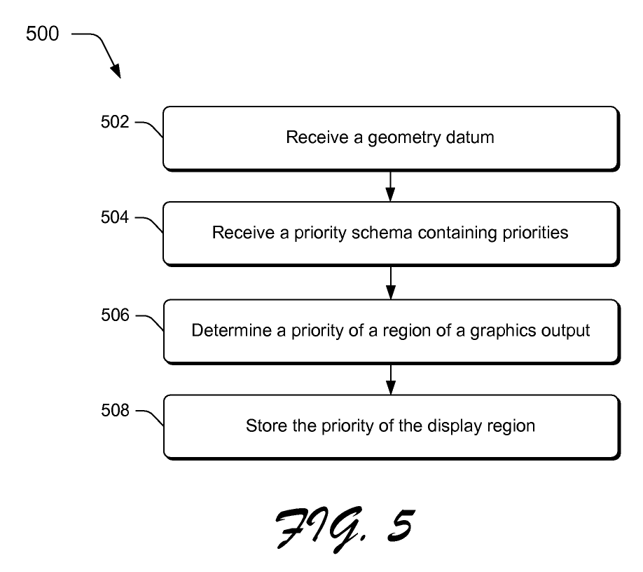

FIG. 5 depicts an illustrative process which allows a remote desktop server to receive geometry data, receive a priority schema containing priorities associated with the geometry data, determine the priority of a region of the graphics output based on the geometry data, and store the priority in a logical mapping of regions to priorities.

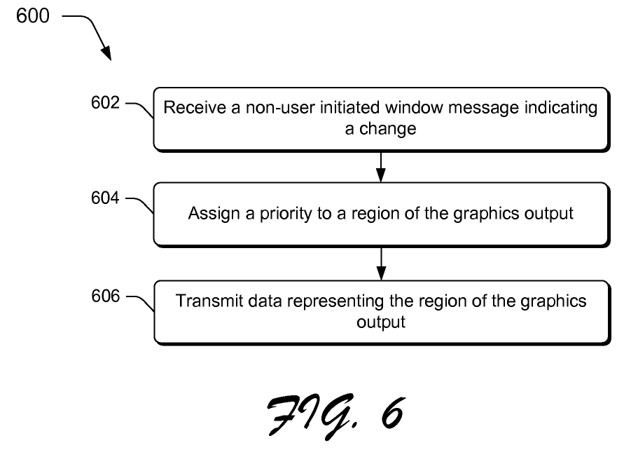

FIG. 6 depicts an illustrative process for receiving a non-user initiated window message, assigning a priority to a region of the graphics output based on the received message, and transmitting data representing the region.

### DETAILED DESCRIPTION

The following discussion targets techniques capable of increasing responsiveness in a remote desktop scenario.

FIG. 1 depicts an illustrative desktop remoting architecture 100. Architecture 100 is separated into a server side 102 and a client side 104, connected by a network 110. The network 110 may be a local area network (LAN), the internet, a wireless network, a 1394 (FireWire) network, or a USB network, among others. The division between the server side 102 and the client side 104 indicates which device is the client and which device is the server in a remote desktop client/server relationship. This client/server relationship is a logical relationship based on which device is actually executing a remote desktop service 126 (the server), and which device is displaying and controlling a remote desktop client application (the client). Therefore, devices located on the server side 102 are not necessarily traditional server computers, and devices located on the client side 104 are not necessarily traditional client computers.

In one embodiment the client is a desktop computer, such as a remote desktop client 114 or a remote desktop client 118. In another embodiment the client is a laptop computer, such as a remote desktop client 116. In other embodiments the client may be a Personal Digital Assistant (PDA), such as a PDA remote desktop client 122, a phone, such as a phone remote desktop client 124, a thin-client, or any other computer device with sufficient resources to operate the remote desktop client application 128. Whatever the device, a user 112 operates one of the client devices, entering input to the client and viewing the representation of the server's display.

In one embodiment the server is a remote desktop server computer 108 running the remote desktop service 126. The remote desktop server computer 108 may be a traditional desktop computer, a laptop computer, or any other computing device capable of operating the remote desktop service 126. In another embodiment the server is a terminal server 106. The terminal server 106 functions to enable one or more remote desktop sessions 120, such as a remote desktop session 120(1). Each of the desktop sessions comprises a logical desktop environment enabled to run applications, respond to user input, and display graphics, among other tasks. However, the user 112 typically does not interact with a remote desktop session from the terminal server 106 directly, but instead connects to the terminal server 106 from the remote desktop client 114 to control the remote desktop session 120(1). Each desktop session runs the remote desktop service 126 to enable this connection. The terminal server 106 can support more than one of the remote desktop sessions 120 concurrently, allowing more than one user to concurrently operate a desktop session.

Both the terminal server 106 and the remote computer 108 comprise an operating system that includes remote desktop capability. In one embodiment the operating system is a Microsoft Windows operating system, such as Windows Vista®, Windows XP®, Windows 2000®, Windows ME®, Windows 98®, Windows 95®, or the like. In other embodiments the operating system is a UNIX® or UNIX®-like operating system such as Solaris®, AIX®, or Linux®.

In one embodiment, the user 112 initiates a connection from the remote desktop client 114 through the network 110 to the terminal server 106. The terminal server 106 creates the remote desktop session 120(1). The remote desktop session 120(1) initiates the remote desktop service 126, which brokers commands and display updates between the terminal server 106 and the remote desktop client 114.

FIG. 2 depicts illustrative sub-components of terminal server 106 and remote desktop client 114. In this embodiment, the terminal server 106 and the remote desktop client 114 form a client/server pair. Here, the remote desktop client 114 operates on the client side 104 of the network 110 and executes the remote desktop client application 128. The terminal server 106, meanwhile, operates on the server side 102 of the network 110 and executes the remote desktop session 120(1). In this environment, the remote desktop client 114 acts as a client of the terminal server 106, thus enabling the user 112 to view and control the remote desktop session 120(1) through the remote desktop client application 128.

In one embodiment, the remote desktop client application 128 receives input from the user 112 and transmits that input through the network 110, the terminal server 106, and the remote desktop session 120(1) to the remote desktop service 126. In one embodiment, the remote desktop client application 128 comprises a client display 230. The client display 230 paints a representation of a graphics output 222 of the remote desktop session 120(1) onto a monitor of the remote desktop client 114. The graphics output 222 may represent a logical or in-memory representation of what would typically be displayed on a local monitor. In remote desktop scenarios, however, this representation is transmitted to the remote desktop client 114 to be displayed on the monitor of the client.

In one embodiment, the terminal server 106 executes the remote desktop session 120(1). As discussed above, the terminal server 106 may simultaneously execute more than one desktop session, with each desktop session being connected to a different remote desktop client.

The remote desktop session 120(1) employs the remote desktop service 126 to enable the remoting of the desktop to the remote desktop client 114. In one embodiment, the remote desktop service 126 is an application running within the remote desktop session 120(1) on the terminal server 106 enabled to detect changes in the graphics output 222 and transmit data representing the changes to the remote desktop client 114. The remote desktop service 126 may maintain or include a priority grid 202, a geometry collector 208, and an operating system 214.

The priority grid 202 is a logical mapping of priorities to regions of the graphics output 222. Each element of the logical mapping contains a priority associated with a region of the graphics output 222. In one embodiment priorities are relative and defined by an ordered set of numbers. In one embodiment priority 0 is the highest priority, priority 1 is the second highest priority, and successively higher numbers indicate a priority ranking inversely proportional to the number. Alternatively, priorities could be represented by characters, symbols, floating point numbers, among others.

Each element's priority is periodically updated based on geometry data received by the geometry collector 208 and information from a priority schema, providing a real-time representation of which regions of the graphics output 222 are assigned which priorities. Priorities may be assigned based on any preference. In one embodiment a set of priorities may attempt to focus updates on regions of the graphics output 222 which the user is likely to be focused on. While the illustrated embodiment divides the screen into a grid having approximately equally-sized regions, other embodiments may divide the screen into regions in other ways. These regions may again be approximately equal in size, or these regions may be of varying size.

However the screen is divided, the remote desktop service 126 uses the priorities stored in the logical mapping to determine which region or regions of the graphics output 222 has been assigned the highest priority. Each of these highest priority regions are then checked for updates. An update exists in a region of the graphics output 222 if that region's image has changed since the last time data representing that region was transmitted to the remote desktop client 114. Updates may be detected by storing a graphics output representing the data that has already been sent to the client, and comparing a region from the stored graphics output with the corresponding region of the current graphics output. Updates may also be detected by maintaining a checksum for each region of the graphics output 222, and comparing the stored checksum with the checksum from the corresponding region of the current graphics output. If an update in one of the regions of the graphics output 222 has been detected, data representing the current region is transmitted to the remote desktop client 114. The same analysis may then occur for the region having the next-highest priority, and so on and so forth. If two or more regions have a same priority, then remote desktop server 122 may employ one or more tiebreakers to determine an order in which to send the data representing these regions. For instance, the service 122 may scan the grid from left to right and top to bottom and may send the data corresponding to the first same-priority region that the service encounters during this scan. Other tiebreakers are similarly envisioned.

In one embodiment, the service 122 may apply a weighted method to prioritizing tiles in order to avoid starvation of tiles with low priorities. The weighted method may choose to send 50% of tiles with priority 1, 30% of tiles with priority 2, and 20% of tiles with priority 3. These percentages are illustrative and not limiting; other percentages are similarly envisioned. If a tile has not been sent for a long period of time, the priority of that tile may be raised to avoid starvation.

In one embodiment, the priority grid 202 is operated on concurrently by two separate streams of execution. A first stream updates elements of the logical mapping in response to some geometry data. Concurrently, a second stream of execution searches the logical mapping, in response to the availability of network bandwidth, for regions to be updated. When the second stream identifies a region to update, it may encode or compress the region before sending data representing the region to the remote desktop client 114. While the second stream is searching for the highest priority regions and encoding or compressing them for transmission, the first stream may be updating the priorities of the regions of the graphics output 222. In one embodiment, the second stream of execution may also contribute to the priority of a region, based on input from the remote desktop client 114 or the availability of network bandwidth.

In one embodiment, the second stream of execution begins searching the logical mapping for regions of the highest priority, checking them for updates, optionally encoding or compressing the regions, and transmitting data representing the region if an update has occurred. As each region's priority is checked, whether an update is transmitted or not, the priority of the region is reset to the lowest priority. After the logical mapping has been searched for elements of the highest priority, the second stream of execution searches the logical mapping for regions with the highest or the second highest priority level. Updated regions are transmitted, and all checked regions are reset to the lowest priority level, or the default priority level. The second stream of execution continues to search the logical mapping at progressively lower priority levels. Regardless of what priority level is being searched for, regions of the highest priority are always checked for updates and processed accordingly.

The geometry collector 208 collects information from the system used to prioritize regions of the graphics output 222. The geometry collector 208 retrieves “push” geometry data and “pull” geometry data from the operating system 214. “Push” geometry data is sent to the geometry collector 208 by the operating system event source 218. “Push” geometry data is received by a push thread 212. In one embodiment, the push thread 212 subscribes to Operating System events. A pull thread 210 periodically retrieves “Pull” geometry data by invoking one or more application program interfaces 216 of the operating system 214. The application program interfaces 216 return information such as the current mouse cursor position, the current caret position, and information about windows, among others discussed below.

The remote desktop client application 128 projects a representation of the graphics output 222 on a client display 230. For purposes of illustration, the client display 230 contains an active window 234, a caret 228, and a mouse cursor 226; however, the client display 230 could display any graphics data stored in the graphics output 222.

In one embodiment, the user 112 operating the remote desktop client 114 initiates a remote desktop connection over the network 110 to the terminal server 106. The terminal server 106 initiates the remote desktop session 120(1), and creates the remote desktop service 126. The graphics output 222 contains a bitmap representation of graphical output generated by the operating system 214 and other applications running in the remote desktop session 120(1). The priority grid 202 is initialized, setting each element of the logical mapping to a default priority. Simultaneously, the geometry collector 208 is initiated and begins receiving geometry data, which is in turn used to update the priorities stored in the logical mapping. Regions of the graphics output 222 are scanned for updates according to the priorities stored in the corresponding elements of the logical mapping. If a change is detected, data representing the region is transmitted to the remote desktop client application 128 of the remote desktop client 114. Upon receiving data representing a region of the graphics output 222, the remote desktop client application 128 uses the data to create an image on the client display 230 that mirrors the corresponding image stored in the graphics output 222.

While the remote desktop client application 128 is receiving data representing regions of the graphics output 222, the remote desktop client application 128 is concurrently receiving user input from a mouse and a keyboard attached to the remote desktop client 114, possibly among other input devices. The received user input is in the form of a user input message. The information contained in the user input message is transmitted over the network 110 to the terminal server 106, and to the appropriate remote desktop service 126. The information representing a user input message is transformed by the remote desktop service 126 into an actual user input message, and sent to the operating system 214 for processing. In this way, the user 112 operating at the remote desktop client 114 sends input messages to the terminal server 106, enabling the user 112 to control applications running on the terminal server 106.

In one embodiment the geometry collector 208 contains two threads of execution, the push thread 212 and the pull thread 210. Here, the push thread 212 may receive operating system events and window messages from the operating system event source 218. These messages and events generally contain information relevant to prioritizing regions of the graphics output 222. More specifically, messages received by the push thread 212 include but are not limited to messages that indicate: that the mouse cursor has moved to a new location, that the caret has moved to a new location, that a particular control is now the active control, that a particular window is now the active window, that a window is about to be or was just scrolled, that a window is about to be or was just moved or resized, that a window was destroyed, and that a region of the screen has been invalidated and should be re-drawn, among others. Examples of a control, also known as a user control, include text boxes, buttons, menus, combo boxes, radio buttons, and check boxes, among others. This information is then used by the remote desktop service 238 to set priorities in the priority grid 202.

While the push thread 212 is receiving window messages and other events containing geometry data, the pull thread 210 periodically requests information from the application program interfaces 216 of the operating system 214. The application program interfaces 216 return geometry data used by the remote desktop service 126 to prioritize regions of the graphics output 222. The information returned from the application program interfaces 216 includes but is not limited to: the current mouse cursor position, the current position of the system caret, the current active control, and the current active window, among others.

The remote desktop service 126 contains a default prioritization schema that assigns priorities to various types or classes of geometry data. In one embodiment, the current position of the mouse cursor is the highest priority. When the current position of the mouse cursor is known, the remote desktop service 126 calculates which region or regions of the graphics output 222 the cursor is least partly within. Elements of the logical mapping associated with the region or regions containing at least a part of the cursor are assigned the highest priority.

In one embodiment, when the current cursor position indicates the highest priority region or regions, the remote desktop service 126 assigns a “priority 0” to elements of the logical mapping that correspond to regions of the graphics output 222 containing at least part of the cursor. FIG. 2 illustrates one example of assigning a priority of 0 to the element or elements of the logical mapping corresponding to regions of the graphics output 222 that contain the cursor of the remote desktop session 120(1).

In one embodiment, the user 112 moves the cursor 226 of the remote desktop client 114 to the upper-right corner of the client display 230. Information indicating this new cursor position is transmitted over the network 110 to the terminal server 106 and to the corresponding remote desktop session 120(1). The remote desktop service 126 converts the information indicating the updated cursor position into a traditional window message, which is sent to the operating system 214. In response, the cursor of the remote desktop session 120(1) is moved to the upper-right corner of the graphics output 222. In one embodiment the pull thread 210 detects this new cursor position. In another embodiment, the push thread 212 is notified of this new cursor position. In either instance, the remote desktop service 126 then assigns a priority of 0 to a set of elements 204 of the logical mapping corresponding to the upper-right corner of the graphics output 222. The next time the remote desktop service 126 scans the logical mapping to determine which region of the graphics output 222 should be checked for updates, the set of regions 204 corresponding to the upper-right corner of the graphics output 222 will be checked for updates first. If a change occurred in one of these regions, for example because a tool-tip appeared in response to the presence of the cursor, data representing the updated region is transmitted to the remote desktop client 114. The remote desktop client application 128 receives the data representing the updated regions, and draws an image representing the updated upper-right corner of the graphics output 222 onto the upper-right corner of the client display 230.

In another embodiment, the position of the caret 228 is received by the pull thread 210 or the push thread 212 and is used to set the priority of elements 206. In one embodiment the priority of the elements 206 is set to 0.

In another embodiment, the size and location of an active control 232 is used to set the priority of elements in the logical mapping corresponding to the size and location of the active control 232. In one embodiment, the priority of the elements corresponding to the size and location of the active control 232 is set to 1.

In another embodiment, the size and location of the active window 234 is used to set the priority of elements in the logical mapping corresponding to the size and location of the active window 234. In one embodiment, the priority of the elements corresponding to the size and location of the active window 234 is set to 2.

In one embodiment, the remote desktop client 114 contains a local cursor 226 used to interact with the client display 230. In one embodiment, the position of the local cursor 226 is used by the priority grid 202 to anticipate where the cursor of the remote desktop session 120(1) will be, once the cursor move message indicating the new cursor position is processed by the operating system 114. This information may then be used to prioritize regions of the graphics display 222.

Similarly, a pseudo-cursor is a cursor generated in application-sharing scenarios. Application sharing scenarios describe two users concurrently viewing and controlling the same application or desktop. So that one user may know what the other user is pointing to, the position of the other user's cursor is painted onto the client display 230. The remote desktop service may in some embodiments use the position of the pseudo-cursor to prioritize corresponding regions of the graphics output 222.

FIG. 3 illustrates a set of exemplary priority schemas 300. FIG. 3 provides three illustrative priority schemas, however any combination or configuration of geometry data and priorities are possible. The configuration may be preset, or may be chosen by a user. In one embodiment, the priority schema may be communicated by the remote desktop client. For example, if the remote desktop client is the phone remote desktop client 124, the priority schema may be very different than the priority schema used when the remote desktop client is a personal computer such as the remote desktop client 114. A priority schema may apply to all applications running on the remote desktop session 120(1), to individual applications, or to a set of applications that vary based on some other criteria.

An illustrative XML priority schema 302 comprises a set of geometry data and priorities assigned to each geometry datum. The XML priority schema 302 may apply to substantially all applications running on the server machine, taking the place of the default priority list. In one embodiment, the last cursor position and the last caret position receive the highest priority (here, priority 0). The priority 0 geometry data are followed by, in descending order of priority, the Current Active Control (Priority 1), Current Active Window (Priority 2), Window Move and Scroll Events (Priority 3), Previous Cursor Position (Priority 4), Window Region Invalidation (Priority 5), and Client Cursor, or pseudo cursor, Position (Priority 6). This ordering of geometry datum priority is illustrative, and is not limited to any specific ordering. In one embodiment, if two types of geometry data are assigned the same priority, the order in which the priorities are listed determines which geometry data type is given the highest priority. Other implementations may employ other tie breaking mechanisms.

An application-specific XML priority schema 304 and an application-specific XML priority schema 306 contain similar mappings of priorities to geometry data as in the XML priority schema 302, but may be used for particular applications. Thus, the application-specific XML priority schemas 304 and 306 enable specific applications with known geometry data profiles to take advantage of this application-specific knowledge. In one embodiment, an application may not respond to the cursor, in which case the application-specific XML priority schema 306 may omit the cursor as a priority. In another embodiment, the application may be particularly focused on command line input, in which case the last caret position may be given a higher priority than the last cursor position. Application-specific XML priority schema 304 illustrates one such priority schema.

FIG. 4 represents an illustrative process 400 for employing the claimed prioritizing techniques described above. Process 400 (as well as subsequent processes) is illustrated as a collection of blocks in a logical flow graph, which represents a sequence of operations that can be implemented in hardware, software, or a combination thereof. In the context of software, the blocks represent computer instructions that, when executed by one or more processors, perform the recited operations.

Operation 402 represents receiving geometry datum from the operating system 214 of the terminal server 106. Operation 404, meanwhile, represents determining the priority of a region of the graphics output 222 based on the geometry datum. As described above, these priorities may be system-wide priority defaults for the particular geometry datum, or may be application specific based on what application or window is active. Operation 406 represents storing the determined priority in the logical mapping. Operation 408 represents identifying the highest priority region of the graphics output 222 based on the highest priority element of the logical mapping. Finally, operation 410 represents transmitting data representing the highest priority region of the graphics output 222.

FIG. 5 represents an illustrative process 500 for prioritizing a region of the graphics output 222 using received a geometry datum and a received priority schema. The priority schema may apply system-wide, or may apply to a specific application or class of applications. Operation 502 represents receiving a geometry datum from the operating system 214. Operation 504, meanwhile, represents receiving a priority schema containing priorities associated with the geometry datum. This priority schema may be the XML priority schema file 302, the application-specific XML priority schema file 304, or some other schema. Operation 506 represents determining a priority of a region of the graphics output 222 based on the geometry datum and the priority schema. Operation 508 represents storing the priority of the region of the graphics output 222 in the logical mapping.

FIG. 6 represents an illustrative process 600 for prioritizing the order in which regions of the graphics output 222 are checked for updates based on a non-user initiated window message, and transmitting data representing the updated regions. Operation 602 represents receiving a non-user initiated window message indicating a change to a computer display. A non-user initiated window message is a system message or an application message that is not created in direct response to user input. In one embodiment, a non-user initiated window message indicates that a window was shown for the first time. In another embodiment, a non-user initiated window message indicates the window is now minimized, maximized, or restored. A non-user initiated window message includes all window messages that do not immediately result from user input. Examples of window messages that ARE user initiated are mouse move events, keyboard events, and button click events, among others. Operation 604, meanwhile, represents assigning a priority to a region of the graphics output based on the message. Operation 606 represents transmitting data representing a region of the graphics output to a remote desktop client.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computer-readable media comprising computer-executable instructions that, when executed on one or more processors, perform acts comprising:
receiving a geometry datum from an operating system;
determining a priority of a region of a graphics output based at least in part on the geometry datum;
storing the priority of the region in a logical mapping of regions to priorities;
determining a highest priority region of the graphics output based on one or more priorities stored in the logical mapping; and
transmitting data representing the determined highest priority region.

2. A method as described in claim 1, wherein the geometry datum is received from a non-user initiated window message.

3. A method as described in claim 2, wherein the non-user initiated message is selected from the group consisting of:
a message indicating a window has been shown for a first time;
a message indicating a window has been set as a foreground window;
a message indicating a window has been scrolled; and
a message indicating a region of a window has been invalidated.

4. A method as described in claim 2, wherein the non-user initiated message indicates one of a position of a pseudo cursor and a previous position of a cursor.

5. A method as described in claim 2, wherein the non-user initiated message indicates the current position of a cursor.

6. A method as described in claim 2, wherein the non-user initiated message indicates the current position of a caret.

7. A method as described in claim 1, wherein the geometry datum is received in response to invoking an operating system application program interface (API) that returns the geometry datum.

8. A method as described in claim 7, wherein the returned geometry datum comprises a current user control, and wherein the current user control comprises the control receiving user input.

9. A method as described in claim 7, wherein the geometry datum comprises a window that is active, and wherein the active window is currently set to receive user input.

10. A method comprising:
receiving a geometry datum from an operating system;
receiving a priority schema containing a set of priorities associated with one or more types of geometry data;
determining a priority of a region of a graphics output based at least in part on the geometry datum and the priority schema; and
storing the priority of the region in a logical mapping of regions to priorities.

11. A method as described in claim 10, wherein the priority schema comprises a set of priorities specific to a single application.

12. A method as described in claim 10, wherein the geometry datum comprises a first geometry datum, and further comprising receiving a second geometry datum from the operating system, wherein the priority schema determines relative priorities of the first geometry datum and the second geometry datum.

13. A method as described in claim 12, wherein the priority schema specifies that a region containing a current cursor position comprises a highest priority region.

14. A method as described in claim 12, wherein the priority schema specifies that a region containing a current caret position comprises a highest priority region.

15. A method as described in claim 10, wherein some elements of the logical mapping of regions to priorities comprises a flag indicating when a region of the graphics output has been checked for changes.

16. A method as described in claim 10, further comprising
identifying a highest priority region of the graphics output based on one or more priorities stored in the logical mapping;
determining whether the highest priority region of the graphics output has changed; and
transmitting data representing the highest priority region to a remote desktop client if the highest priority region has changed.

17. A method comprising:
receiving a non-user initiated window message that indicates a change to a graphics output;
assigning a priority to each of multiple regions of the graphics output based at least in part on the received non-user initiated message; and
transmitting data representing one or more regions of the graphics output to a remote desktop client in an order based at least in part on the assigned priorities.

18. A method as described in claim 17, further comprising assigning a priority to each region of the graphics output based at least in part on the following:
a change in a position of a cursor;
a change in a position of a caret;
a change in an active control;
a change in an active window;
a window being shown for a first time;
a window being set as a foreground window;
a window being scrolled;
a window being destroyed;
a window being moved; and
a region of a window being invalidated.

19. A method as described in claim 17, wherein the priority of a region of the graphics output is based at least in part on a position of a pseudo-cursor.

20. A method as described in claim 17, wherein the non-user initiated message indicates a position of a cursor.
